(19) United States
(12) Patent Application Publication
(10) Pub. No.: US 2012/0271774 A1
(43) Pub. Date: Oct. 25, 2012

(54) INTERVIEW FRAMEWORKS

(75) Inventor: Peter Melvin Clegg, Orem, UT (US)

(73) Assignee: HIREVUE, INC., Draper, UT (US)

(21) Appl. No.: 13/091,308

(22) Filed: Apr. 21, 2011

(51) Int. Cl. G06Q 10/00

(52) U.S. Cl. 705/321

(57) ABSTRACT

Selecting interview questions to be posed to an interviewee. A method includes receiving user input. The user input selects an interview evaluation system from among a number of different interview evaluation systems. Each interview evaluation system in the number of different interview evaluation systems includes functionality for at least one of scoring interview interactions or rating interviewees. At least two or more of the interview evaluation systems from among the number of different interview evaluation systems include different functionality for scoring interview interactions or rating interviewees. Based on the user input selecting an interview evaluation system, a set of interview queries from among a plurality of pre-defined interview queries are automatically selected. The selected set of interview queries are provided for use in an interview of an interviewee.

### BACKGROUND

### Background and Relevant Art

Finding and hiring employees is a task that impacts most modern businesses. It is important for an employer to find employees that “fit” open positions. Criteria for fitting an open position may include skills necessary to perform job functions. Employers may also want to evaluate potential employees for mental and emotional stability, ability to work well with others, ability to assume leadership roles, ambition, attention to detail, problem solving, etc.

However, the processes associated with finding employees can be expensive and time consuming for an employer. Such processes can include evaluating resumes and cover letters, telephone interviews with candidates, in-person interviews with candidates, drug testing, skill testing, sending rejection letters, offer negotiation, training new employees, etc. A single employee candidate can be very costly in terms of man hours needed to evaluate and interact with the candidate before the candidate is hired.

Computers and computing systems can be used to automate some of these activities. For example, many businesses now have on-line recruiting tools that facilitate job postings, resume submissions, preliminary evaluations, etc. Additionally, some computing systems include functionality for allowing candidates to participate in “virtual” on-line interviews.

Evaluation of candidates can be a very subjective process that is highly dependent on individual interviewers. However, large organizations may wish to remove or minimize subjectivity to maximize recruiting efforts, avoid charges of discrimination, or for other reasons. Various schemes exist to this end, but each of these schemes approaches the solution in different ways. Thus, an employer that makes a commitment to a provider of an automated interview and/or evaluation system is often constrained to that provider's solution.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment includes a method practiced in a computing environment configured to automate at least a portion of interview processes. The method includes acts for selecting interview questions to be posed to an interviewee. The method includes receiving user input. The user input selects an interview evaluation system from among a number of different interview evaluation systems. Each interview evaluation system in the number of different interview evaluation systems includes functionality for at least one of scoring interview interactions or rating interviewees. At least two or more of the interview evaluation systems from among the number of different interview evaluation systems include different functionality for scoring interview interactions or rating interviewees. Based on the user input selecting an interview evaluation system, a set of interview queries from among a plurality of pre-defined interview queries are automatically selected. The selected set of interview queries are provided for use in an interview of an interviewee.

Another embodiment includes a method of defining an interview evaluation system for a set of interview evaluation systems. Each interview evaluation system in the set of interview evaluation systems includes functionality for at least one of scoring interview interactions or rating interviewees. At least two or more of the interview evaluation systems from among the set of interview evaluation systems include different functionality for scoring interview interactions or rating interviewees. The method includes receiving user input selecting an interview evaluation system name for an interview evaluation system. The method further includes receiving user input selecting one or more questions from among a plurality of questions for a first set of questions for the interview evaluation system. At least one or more same questions in the plurality of questions are selected to belong to different interview evaluation systems such that at least two interview evaluation systems have overlapping questions. The method further includes receiving user input selecting interviewer question rating criteria. The method further includes defining the interview evaluation system to include the first set of questions for the interview evaluation system and the interviewer question rating criteria.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an interview framework hierarchy illustrating a plurality of frameworks that may be managed by a system;

FIG. 2A illustrates a first framework builder screen for naming a framework and defining category types;

FIG. 2B illustrates a second framework builder screen for further defining a framework;

FIG. 2C illustrates a third framework builder screen for further defining a framework;

FIG. 2D illustrates a fourth framework builder screen for further defining a framework;

FIG. 2E illustrates a first question creator screen for defining questions in a framework;

FIG. 2F illustrates a second question creator screen for further defining questions in a framework;

FIG. 2G illustrates form builder screen for building an interview form;

FIG. 3 illustrates an administrator screen that allows options to be set for different frameworks;

FIG. 4 illustrates a templates list screen used to view and organize interview templates;

FIG. 5 illustrates a job setup screen that allows an administrator to formalize

FIG. 6A illustrates an example interview screen;

FIG. 6B illustrates another example interview screen;

FIG. 6C illustrates another example interview screen;

FIG. 6D illustrates another example interview screen;

FIG. 6E illustrates another example interview screen;

FIG. 6F illustrates another example interview screen;

FIG. 7 illustrates a method of selecting interview questions to be posed to an interviewee; and

FIG. 8 illustrates a method of defining an interview framework.

### DETAILED DESCRIPTION

Some embodiments described herein allow for defining and/or using different interview frameworks. An interview framework defines a specific interview methodology. For example, a specific interview methodology defines how questions are asked and evaluated, and how candidates are evaluated in view of their answers to questions.

Different interview frameworks, may nonetheless, use the same or similar questions. For example, many different interview frameworks may indicate that questions should be asked of candidates indicating how they responded to a difficult situation at work. Different frameworks may ask questions related to job skills. Different frameworks may ask questions related to conflict management. And so forth. Thus, embodiments may allow for questions to be reused across frameworks.

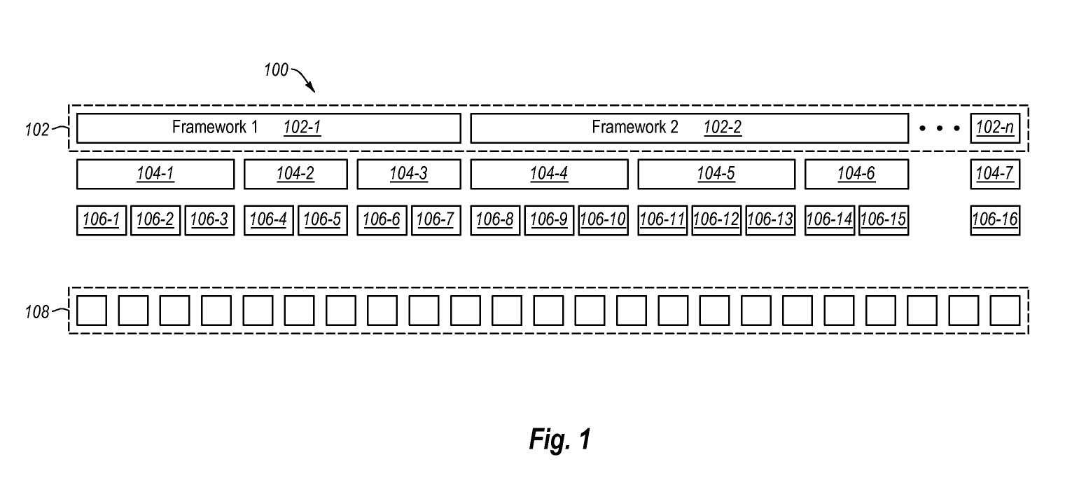

Interview frameworks may be organized into a hierarchy with the interview framework at the top of the hierarchy and individual questions at the bottom of the hierarchy. Between the top and bottom of the hierarchy are other subdivisions useful for organizing questions and/or evaluation criteria. An example is illustrated in FIG. 1.

FIG. 1 illustrates a system hierarchy 100 where the system hierarchy supports multiple interview framework hierarchies. FIG. 1 illustrates a set of frameworks 102. As illustrated, the set of frameworks 102 includes a number of frameworks including 102-1, 102-2 and 102-n, where the ellipsis and “n” designator indicate that a variable number of frameworks may be supported by the system. A framework represents a specific interview methodology. The framework may include questions organized in a particular fashion as illustrated below. Additionally, the framework will typically include specifics about how interviews are conducted with regards to: rating scale, question rating instruction, use of question probes, use of comments, candidate rating, etc. In general, once a framework is defined and selected, relevant characteristics, formats and question elements will be of the same or similar format.

In the illustrated example, each interview framework includes below it one or more category types, referred to herein generally as 104, but illustrated specifically as 104-1, 104-2, 104-3, 104-2, 104-4, 104-5, 104-6, and 104-7, where category types 104-1, 104-2, 104-3 are below interview framework 102-1; category types 104-2, 104-4, 104-5, 104-6, are below interview framework 102-2; and category type 104-7 is below framework 102-n. Category types define sets, collections or classes of categories. Examples of category types for one framework include “competency”, “job family”, and “question type”.

Below the category types are question categories referred to herein generally as 106, but illustrated specifically as 106-1, 106-2, 106-3, 106-2, 106-4, 106-5, 106-6, 106-7, 106-8, 106-9, 106-10, 106-11, 106-12, 106-13, 106-14, 106-15, and 106-16. In the example illustrated, question categories 106-1, 106-2, and 106-3 are below category type 104-1; question categories 106-4 and 106-5 are below category type 104-2; question categories 106-6 and 106-7 are below category type 104-3; question categories 106-8, 106-9 and 106-10 are below category type 104-4; question categories 106-11, 106-12 and 106-13 are below category type 104-5; question categories 106-14 and 106-15 are below category type 104-6; and question category 106-16 is below category type 104-7. Categories generally group questions around characteristics or general areas. For example, the categories of questions under the “competency” category type might be “numeric aptitude” and/or “emotional resilience”.

FIG. 1 further illustrates a set of questions 108. Each of the questions under the set of questions 108 are not necessarily under only a single question category 106. Rather, a single question may belong to different question categories 106, different category types 104 and/or different frameworks in the set of frameworks 102. Thus, questions can be shared among different frameworks or different portions of the same framework.

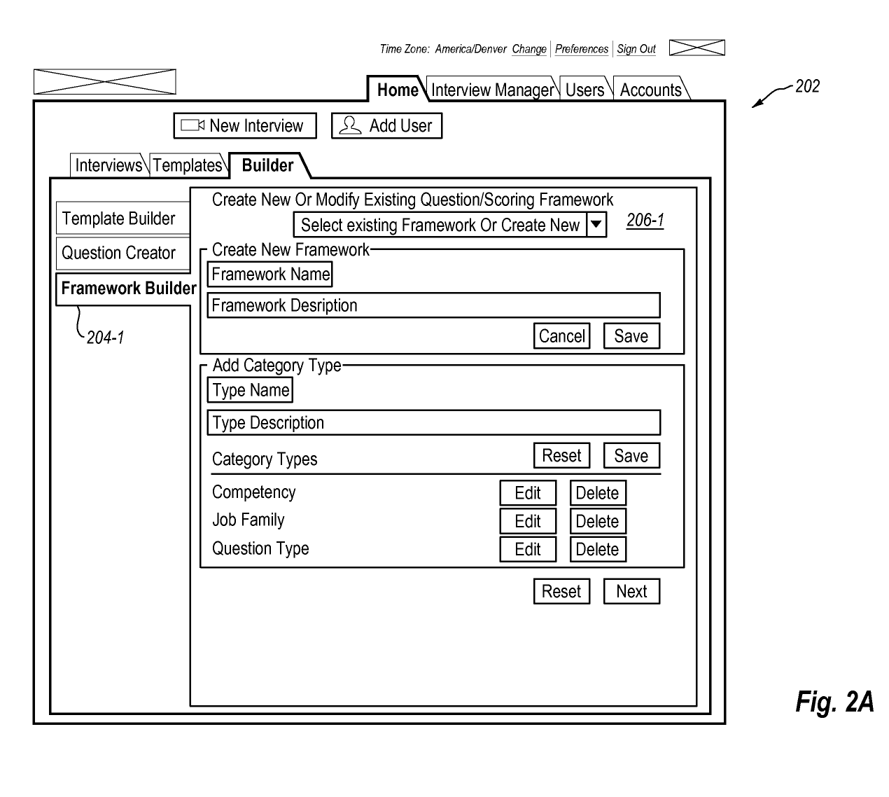

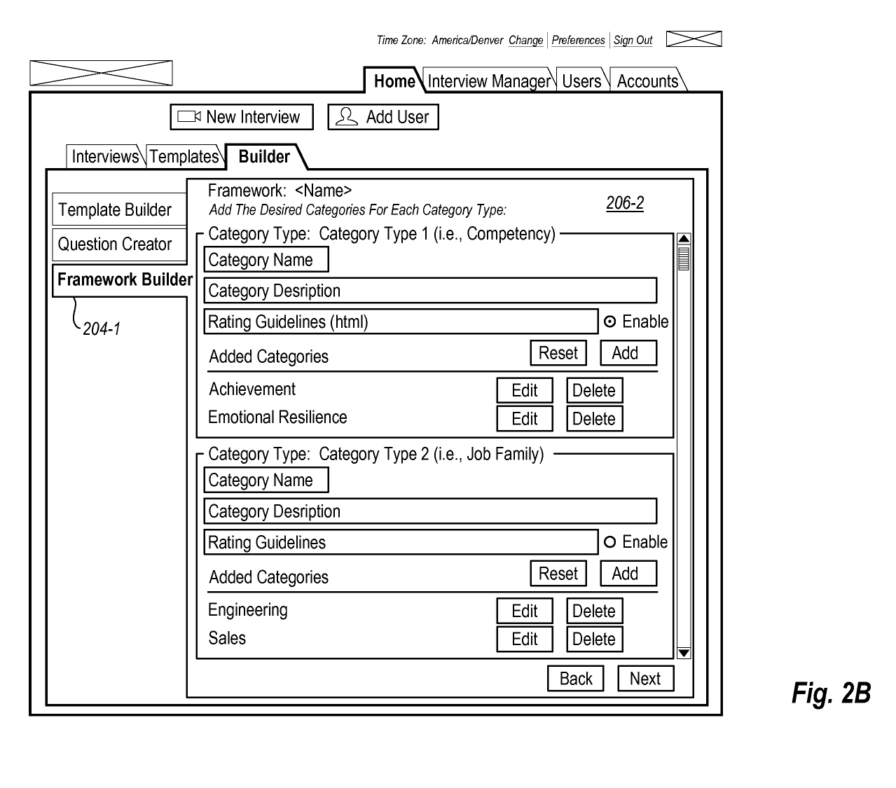

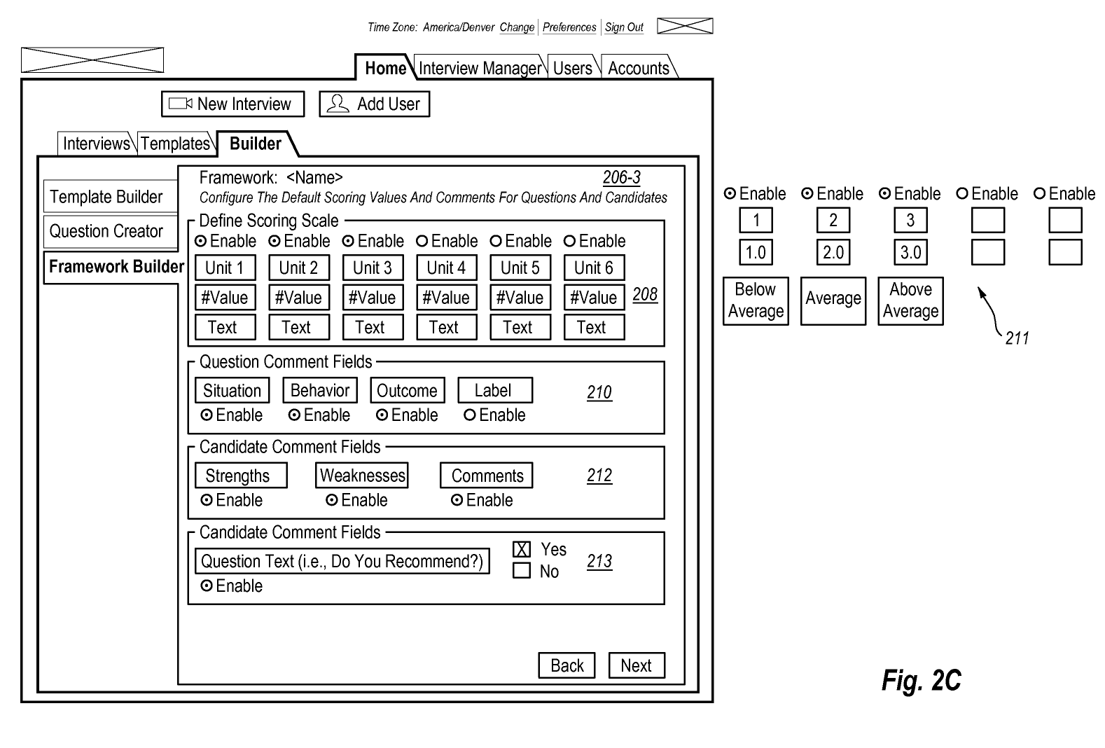

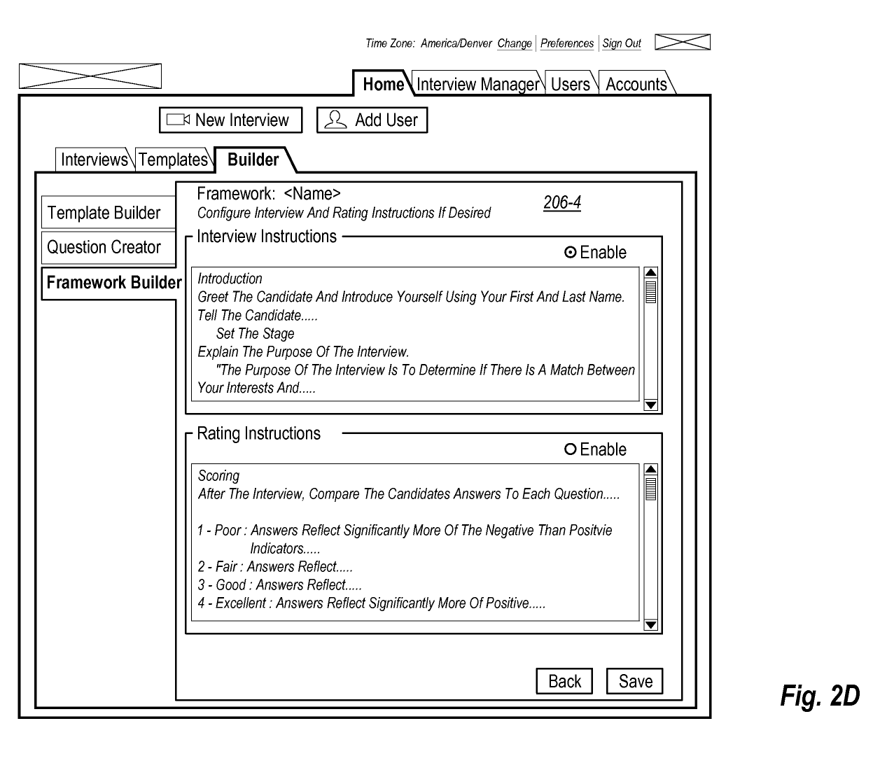

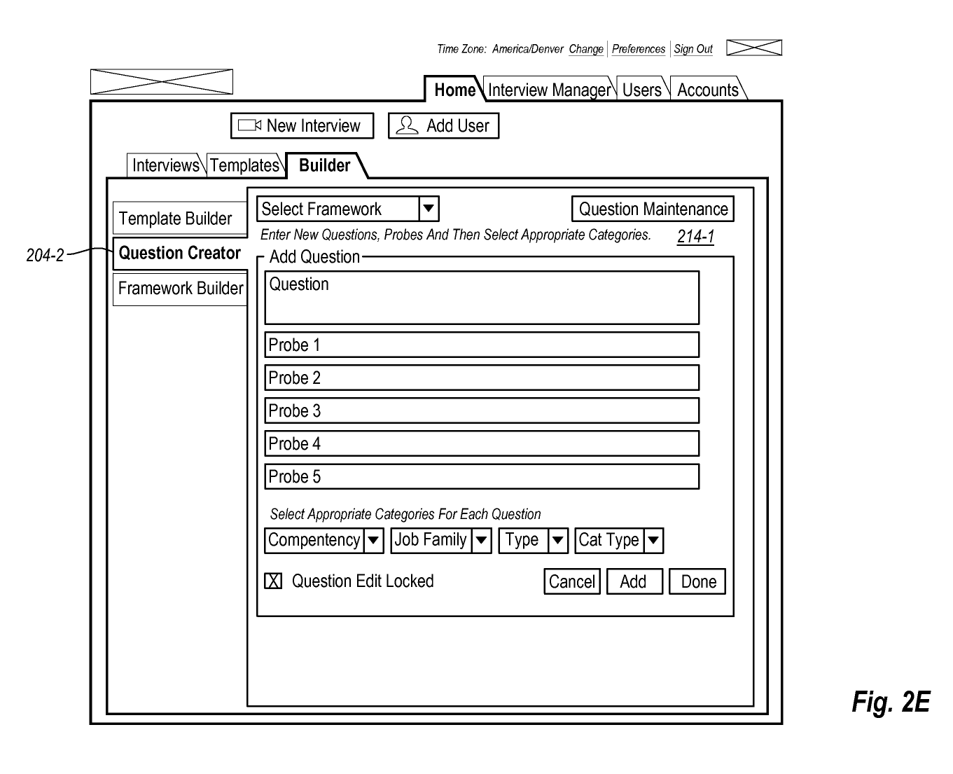

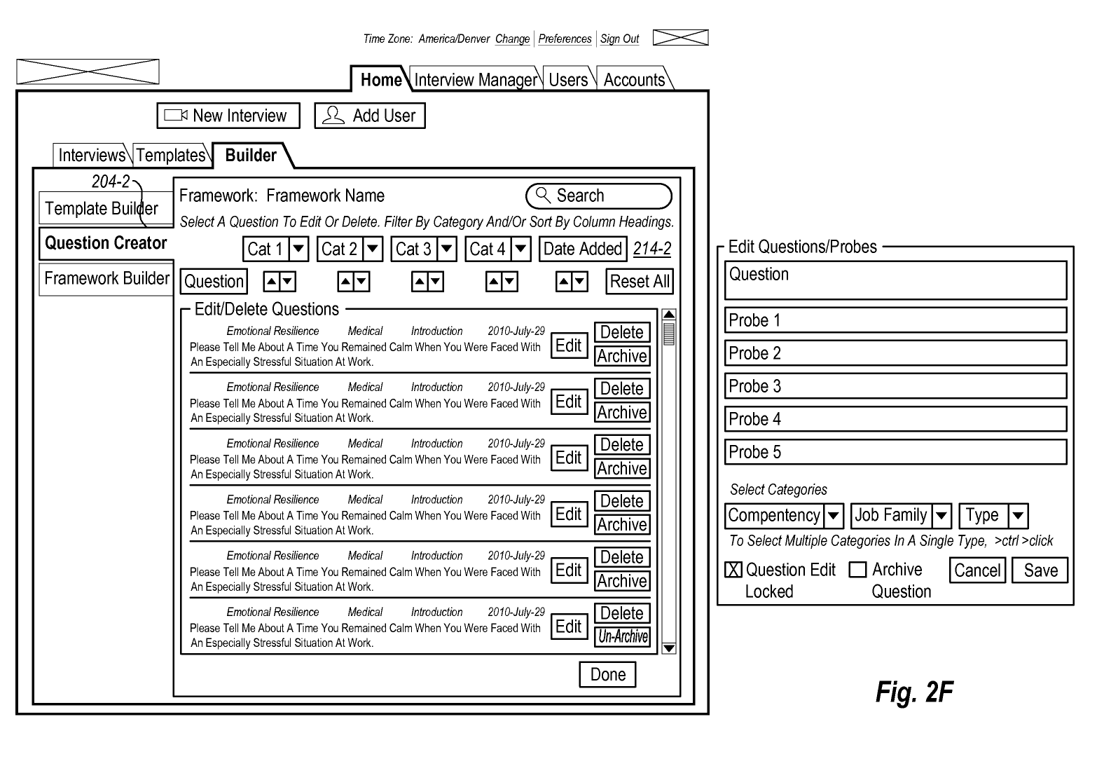

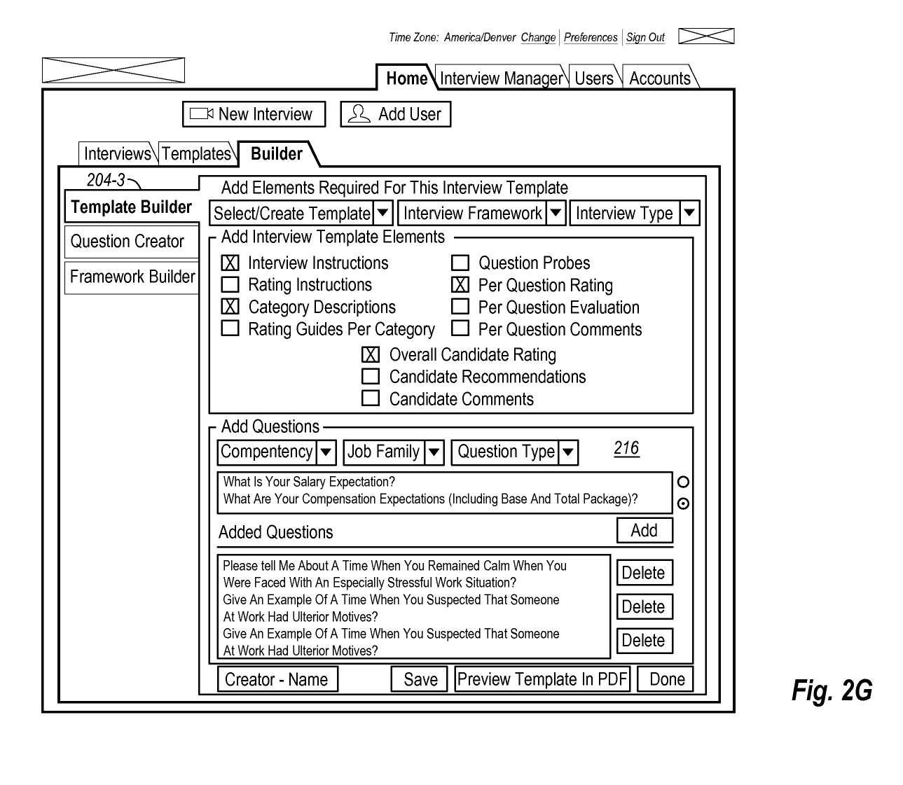

Referring now to FIGS. 2A-2G, a graphical user interface is illustrated. The graphical user interface may be rendered by a computing system, and allows a user to develop or change frameworks.

Referring now to FIG. 2A, a framework builder interface 202 for defining, editing, and otherwise managing frameworks is illustrated. In some embodiments, the framework builder interface 202 is only able to be interacted with if a user possesses appropriate security credentials. For example, in some embodiments, the framework builder interface 202 may only be able to be interacted with by a user who is logged in as an administrator or a superuser. In some embodiments, the framework builder interface 202 may only be available to an interview services provider. In particular, some embodiments may be implemented where the end user, who will be interviewing candidates, will not have the framework builder interface 202, and hence framework building capabilities available. Rather, a provider company that services an end user with customer or vendor specific interview criteria may have functionality to build frameworks using the framework builder interface 202. However, this does not prohibit other embodiments from allowing end users to create frameworks using a framework builder, including user interfaces such as those illustrated in the framework builder interface 202.

FIG. 2A illustrates a framework builder tab 204-1. FIG. 2A further illustrates a first screen 206-1. In particular, the framework builder tab 204-1, in this example, is organized as a wizard interface where a user progresses through a series of screens to create or modify a framework. In the first screen 206-1, the user can select an existing framework to modify or create a new framework. The user can add or change a framework name. The user can add or change a framework description. The user can add the category type to a framework. The user can add a category type name to a category type. The user can add a category type description to a category type. The user can manage category types by editing and/or deleting category types.

Referring now to FIG. 2B a second screen 206-2 is illustrated. The second screen 206-2 illustrates the second screen in the wizard interface of the framework builder tab 204-1. The second screen 206-2 is populated with each of the category types that were defined in the first screen 206-1. In the second screen 206-2, users can add actual question categories under each category type. The actual question categories may include category descriptions and rating guidelines, if enabled. Illustratively, assume the first category type previously defined was “competency”. Within this category type there may be several question categories. For example, the first category may be “achievement focus.” A description can be provided for this question category. For example the description may be “setting and accomplishing goals.” Additionally, rating guidelines may be included for a particular question category. For example, in the present example such guidelines may be “below”=“no interest,” “average”=“found satisfaction,” and “above average”=“successfully accomplished goals.”

It should be appreciated, that in some embodiments question categories can be the child and/or a parent to other categories. These relationships may be established through programming or other appropriate means.

Referring now to FIG. 2C, a third screen 206-3 of the wizard interface of the framework builder table 204-1 is illustrated. The third screen 206-3 includes user interface elements to allow a user defining or changing a framework to define or change question scoring methodology. In particular, in the example illustrated, for each framework a scoring definition determines how many scoring options will be available, what they are called, what numeric value is assigned and whether comments are available per question and/or per candidate.

As illustrated in FIG. 2C the third screen 206-3 includes a “Define Scoring Scale” section 208. The “Define Scoring Scale” section 208 allows a user to determine the number of options available on a scoring scale, the value for each option, and each actual description for each option. Each option is illustrated as a unit in the “Define Scoring Scale” section 208. Illustratively, each unit may have a text name, such as “1” or “D” or “poor”, etc. Each unit may have a value assigned to the unit as illustrated by the #Value boxes. The value illustrated may be for example a numeric value used for scoring an interviewee's responses. The text field may include an actual description, such as “below average,” or some other detailed text. An example 211 of a populated scoring scale is illustrated in FIG. 2C.

FIG. 2C further illustrates a “Question Comment Fields” section 210. The “Question Comment Fields” section 210 includes fields that are associated with each question and available to an interviewer and/or a reviewer for comment. Each framework can have structured comment fields that vary with a particular model. For example, one model may require user input for each question evaluation answering what was the “situation”, “behavior” and “outcome”. Another may structure question comments in the form of “positives” and “negatives.” Comment Fields may be labeled. In some embodiments the default label name is “Comments” if the field is left blank but the comment is enabled.

FIG. 2C further illustrates a “Candidate Comment Fields” section 212. The “Candidate Comment Fields” section 212 includes candidate comment fields that are associated with each candidate and/or summary comments at the end of an interview. Similar to the question comment fields described above, each framework can have structured comment fields for candidate fields that vary with the model. For example, a model could require structured response in form of “positives” and “negatives” or just “comments. The comment fields may be labeled. However some embodiments may be implemented where the default label name is “Comments.”

FIG. 2C further illustrates a “Candidate Recommendation” section 214. The “Candidate Recommendation” section 213 includes a candidate recommendation text field. The candidate recommendation text field may include wording presented to a reviewer for a final decision on whether or not a candidate should be hired.

Referring now to FIG. 2D, a fourth screen 206-4 is illustrated. The fourth screen 206-4 of the wizard interface allows a user to provide interview instructions and/or rating instructions. In particular, embodiments may be implemented where interview instructions and/or rating instructions appear at the beginning of each interview if such instructions are enabled. Instructions may be formatted in a particular way. For example, in one embodiment formatting can be accomplished with the ability to have HTML format editing during text input to allow for formatting such as bold, font size, bullets, etc. In some embodiments, HTML can be simply pasted in the appropriate text input boxes for interview instructions and/or rating instructions.

Referring now to FIG. 2E, a question creator tab 204-2 is illustrated. The question creator tab 204-2 can be used to add questions and probes. Additionally, the question creator tab 204-2 can be used to categorize questions and/or probes. A question represents an initial interview query made to an interviewee. A probe represents promptings to an interviewer to further explore interviewee responses to a question.

FIG. 2E further illustrates a first screen 214-1 of the question creator tab 204-2. In the first screen 214-1, questions can be added and categorized. As illustrated in FIG. 2E, a user can first select a framework. The categories associated with the framework will appear for selection, as illustrated at the bottom of the first screen 214-1. Additionally, if probes were enabled in the framework, they can be input here in the probe input boxes shown in FIG. 2E. Question maintenance allows for editing, deleting, and other access to all questions in a particular framework. In some embodiments, questions can be input in HTML format to accommodate question formatting, such as bolding, bullets, etc. Additionally, some embodiments may include functionality to identify and import previously written and categorized questions. In some embodiments these prior written and categorized questions can be included through xml input. An xml parsing comparison module may be used to appropriately identify question subject matter or other characteristics of a question.

As illustrated in FIG. 2E, some embodiments include functionality to lock editing of questions. In these embodiments, questions that are locked are not editable. In some embodiments, as additional questions are added, the locked state of the question will be the same as the last selection. For example, selecting lock for one question will leave the state as locked for the next question and remains so until unlocked. However, other embodiments may include a default state of locked or unlocked which can be changed by a user if a different state is desired by the user.

Referring now to FIG. 2F, a second screen 214-2 of the question creator tab 204-2 is illustrated. The second screen 214-2 is a maintenance screen which allows an administrator to find, filter and edit previously created questions. For example, a user can manage existing questions by searching to find questions, filtering by category or date range, sorting columns, etc. In the illustrated example an edit button may be selected by a user. When the edit button is selected for a question, an interface, such as a popup window, may be presented to a user where the user can modify the question, probes, categories etc. As illustrated in the present example, the second screen 214-2 further includes a delete button for each question. The delete button can be used to remove a question from the library entirely and from all templates and forms. However, deleted questions may nonetheless remain as part of an interview where the interview has already been completed. FIG. 2F further illustrates an archive button associated with each question. Selecting the archive button may archive a question. Archiving a question removes it from the active question library, but allows it to remain in the template for forms where it already resides. When archived, the questions and options change state such that an un-archive button appears in place of the archive button. Such an example is illustrated in FIG. 2F in the last question shown in the list.

Referring now to FIG. 2G, a form builder tab 204-3 is illustrated. The form builder tab 204-3 allows a user to create a full interview form and to save the full interview form. In some embodiments, full interview forms can be created by an interview service provider to an interview customer, where the interview customer is an entity desiring to interview candidates. As illustrated in FIG. 2G, a user can select a template as illustrated by the “Select/Create Template” drop down selection menu. This allows a user to select from existing templates or to create a new template. If a new template is selected, one or more user interface elements, such as a popup box, may be used to allow the template name and description to be input and saved. The name of the template will then appear in the “Select/Create Template” drop down selection menu.

FIG. 2G further illustrates an “Interview Framework” drop down selection menu. If more than one framework is available for a particular customer, the “Interview Framework” drop down selection menu will be selectable to allow the user to select an interview framework.

As illustrated in FIG. 2G, an “Interview Type” drop down selection menu can be used by a user to select an interview type. In the illustrated example, the options may be a one-way or a two-way interview. One way interviews may be conducted by providing an interviewee with questions in an un-manned fashion. For example, an interviewee could interact with automated interview software or fill out a printed questionnaire. Two-way interviews may involve a live interviewer and interviewee. However, the interview may nonetheless be either in person, or using technology such as on-line tools, telephone, etc. Depending on the question type, (i.e. one-way or two-way) only certain options may be available to include in an interview. For example, question probes may not be available for some one way interviews. However, some one way interviews may allow for probes by use with text recognition and artificial intelligence to select or formulate probes.

FIG. 2G further illustrates an interview template elements section. This allows a user to select elements that are available to an interviewer. In some embodiments, only elements available within the selected framework or that are appropriate to an interview type will be selectable. For example certain frameworks use particular evaluation criteria, and thus, only elements appropriate for the particular evaluation criteria will be selectable.

FIG. 2G further illustrates an “Add Questions” section 216. In this particular interface element, question categories are available based on a framework selected. Each framework has different question category types available. Selecting different category types results in different categories and subsequently different questions being made available that can be selected by a user to add to an interview template for an interview. In the illustrated example, the user selects categories from the competency category type, the job family category, and the question type. The user is then presented with a list of questions to select from. Clicking “add” adds the questions to the interview template and resets the window to add another question. Clicking “done” saves the template and returns the user to the main menu. The template builder tab 204-3 further includes a preview template button, which in this example, allows preview of an entire interview form in a pdf or text format. The form builder tab 204-3 further includes the ability to add a creator name or associated a creator based on the current user login ID. In the present example the default creator name is the name of the user. However, the creator name could be a person, department, or company. The creator name may be a text field which indicates source of the interview.

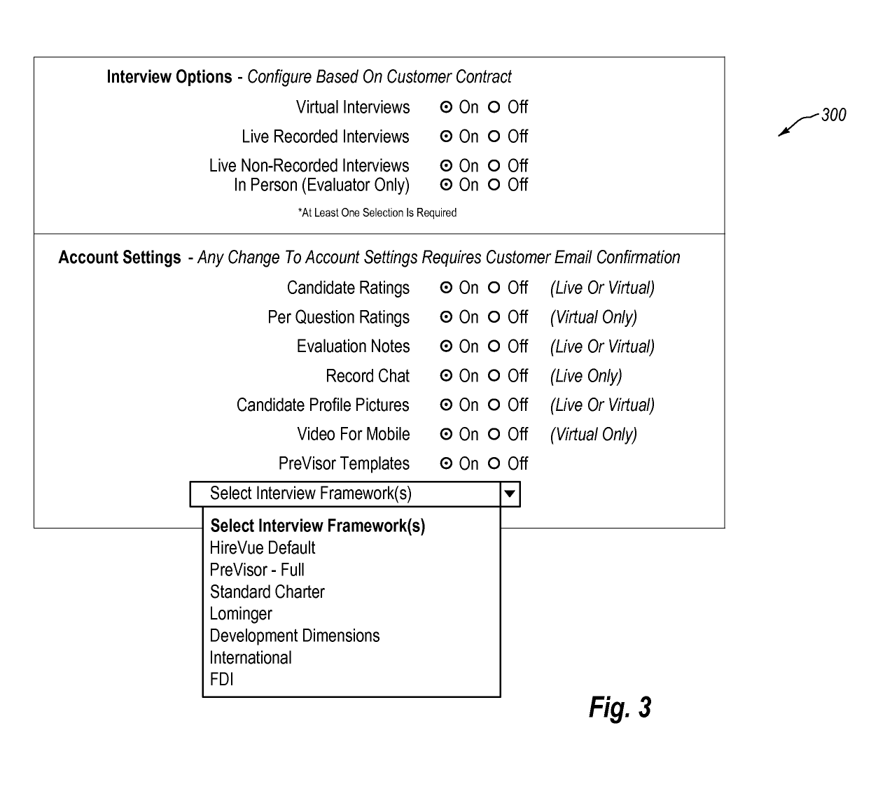

Referring now to FIG. 3, an administrator screen 300 is illustrated. The administrator screen 300 allows one or more frameworks upon which an interview form is based to be selected. In the example illustrated in FIG. 3, if an administrator wants to create an interview based on multiple frameworks, the administrator can hold down the <ctrl> key to make multiple selections.

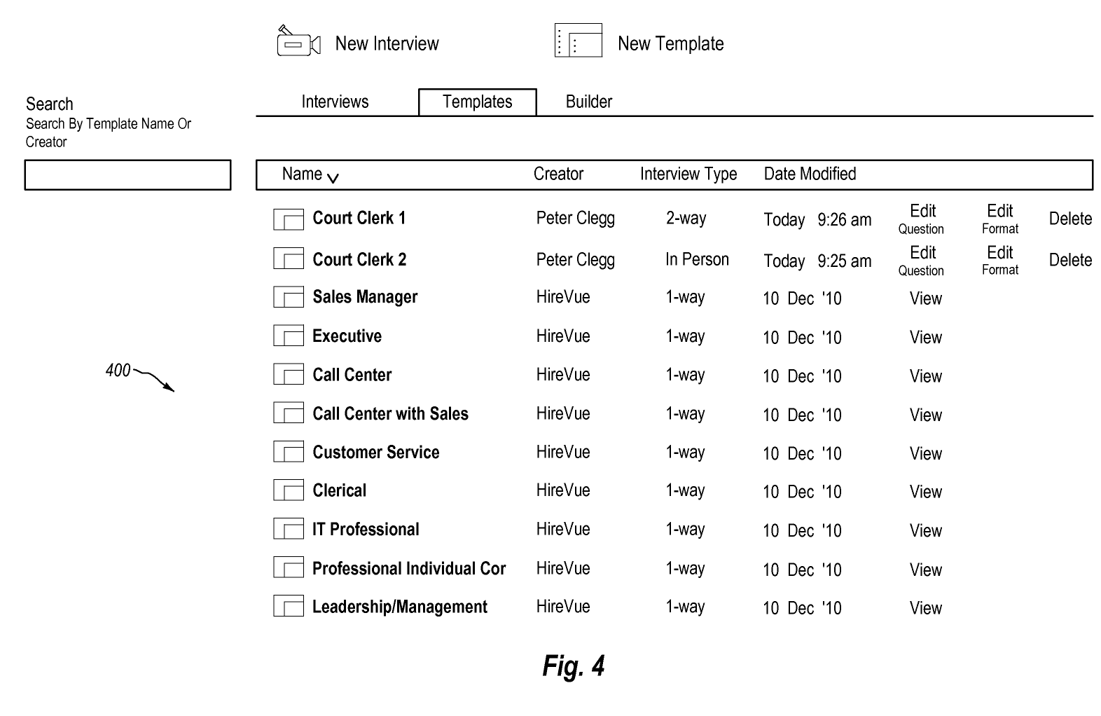

Referring now to FIG. 4, a templates list screen 400 is illustrated. The templates list screen 400 can be used to view and organize interview templates. The templates list screen 400 includes various features to allow templates to be sorted by various criteria including template name, template creator, interview type, last modified date, etc. The templates list screen 400 further includes various user interfaces to allow interview templates to be edited. For example, FIG. 4 illustrates a number of “Edit Question” links The “Edit Question” links takes a user to the first screen 214-1 of the “Question Creator” tab 204-2 illustrated in FIG. 2E. Similarly, FIG. 4 illustrates “Edit Format” links The “Edit Format” links take a user to the “Form Builder” tab 204-3 illustrated in FIG. 2G.

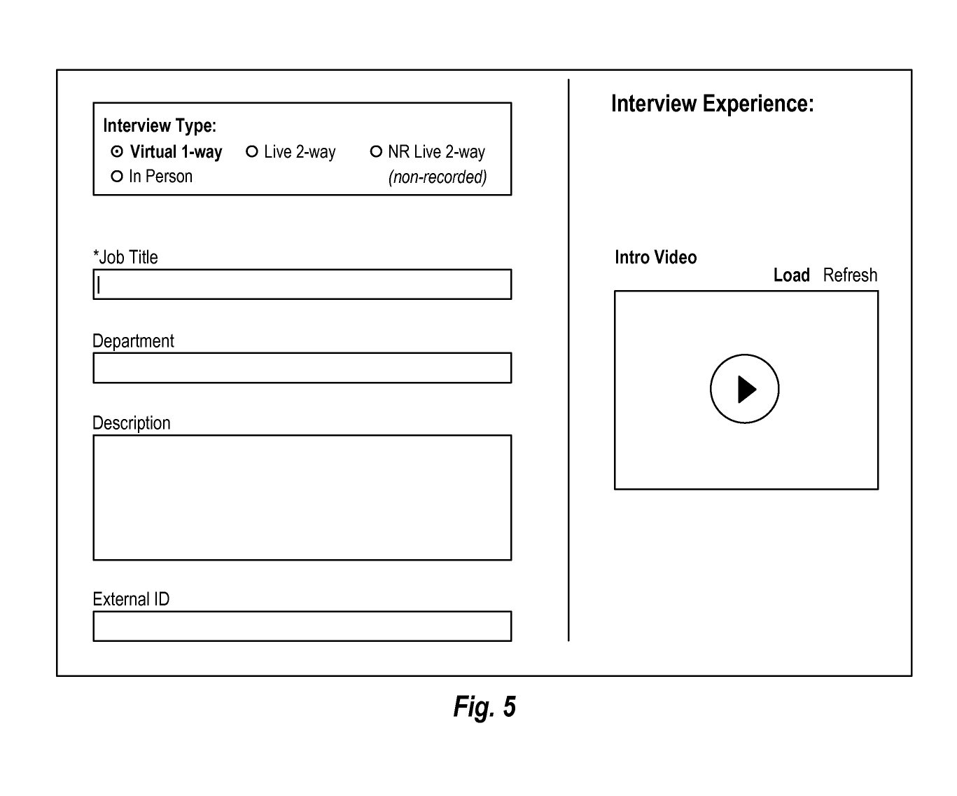

Referring now to FIG. 5, a “Job Setup” screen is illustrated. The “Job Setup” screen allows an interview form for a particular job to be defined. Here, an administrator can select the interview type, job title, department for the job, a description of the job, and an identifier, such as a requisition identifier, for the job, etc. Embodiments may also allow videos to be added. Such videos may include various messages such as introduction videos to a company or job that plays before an interview, and videos thanking the candidate and/or providing additional information regarding timeframes for candidate selection after the interview.

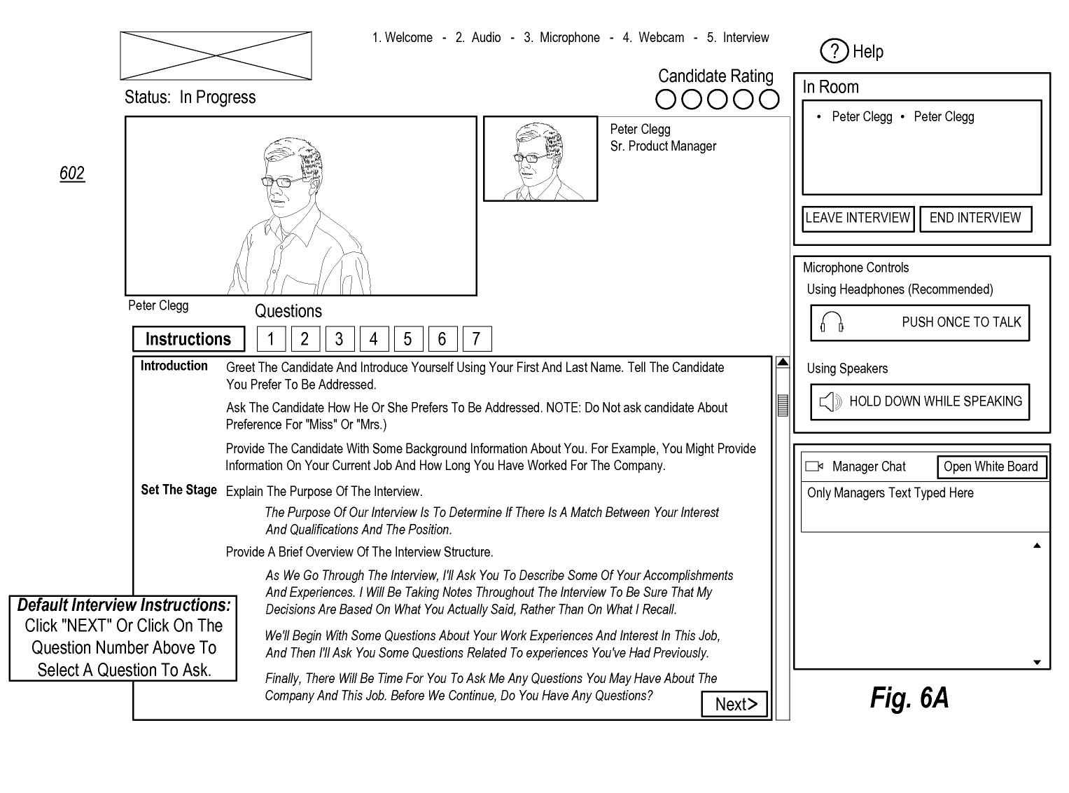

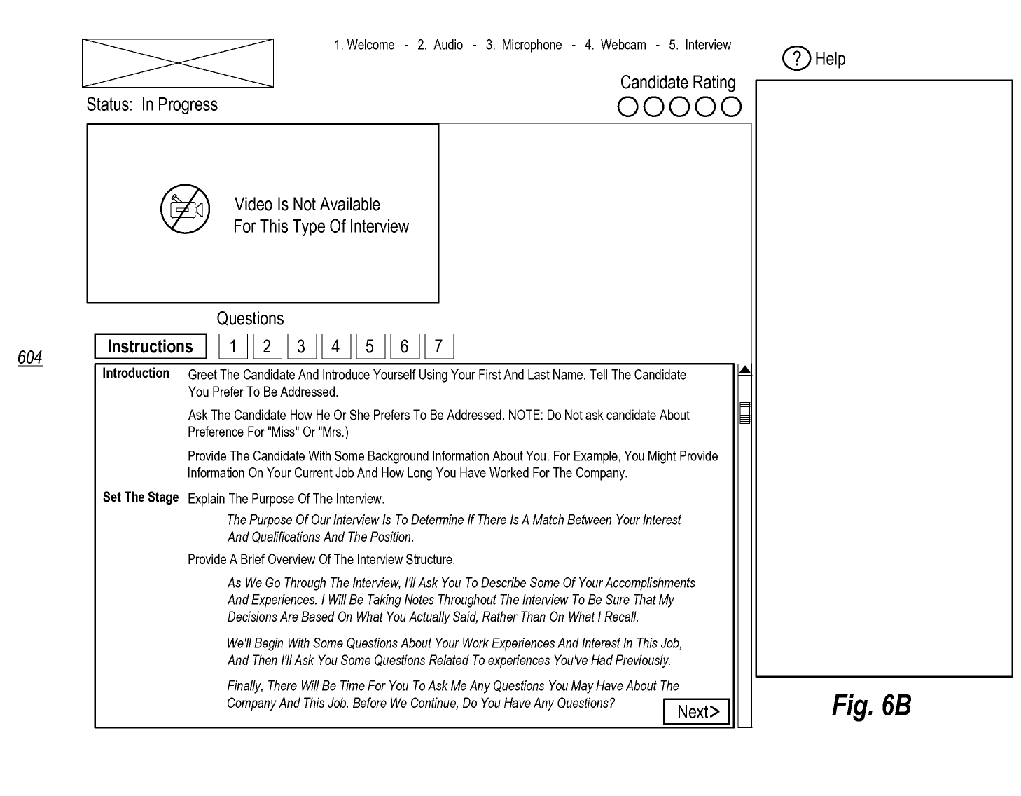

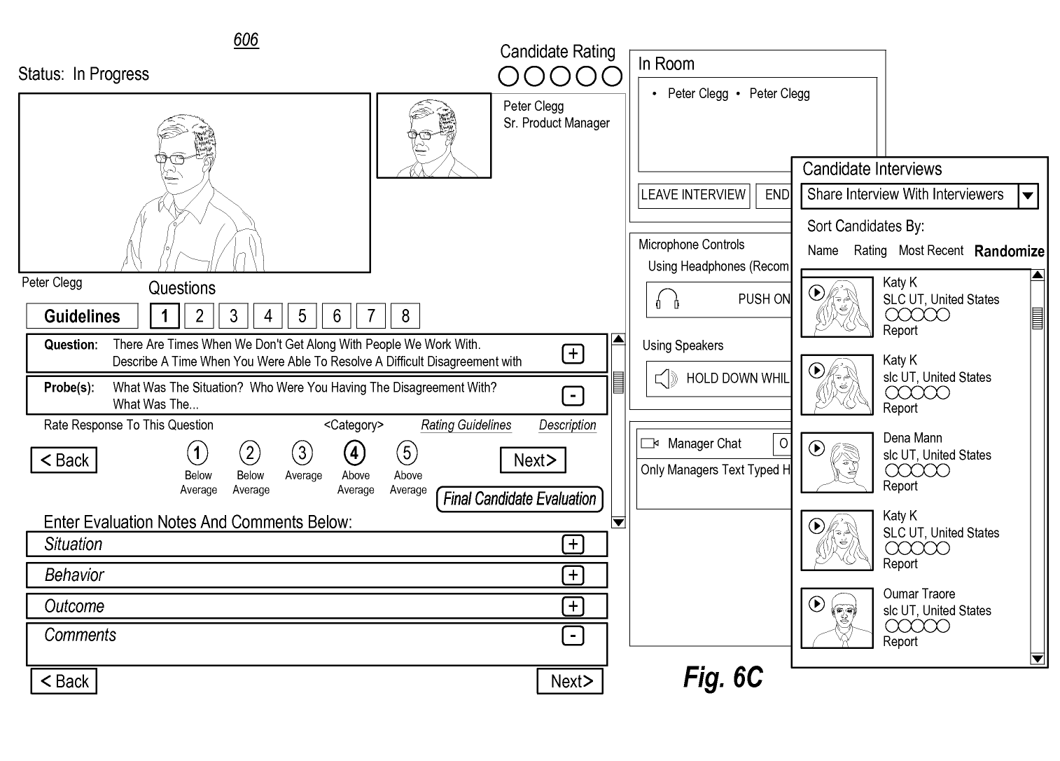

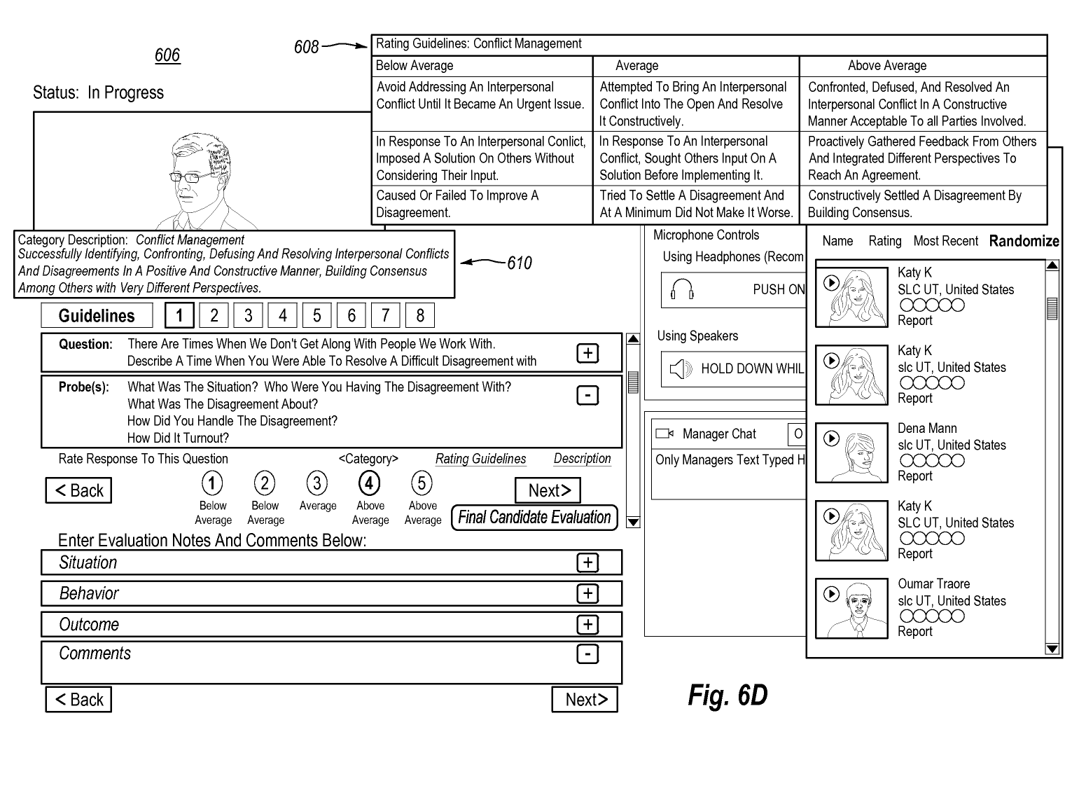

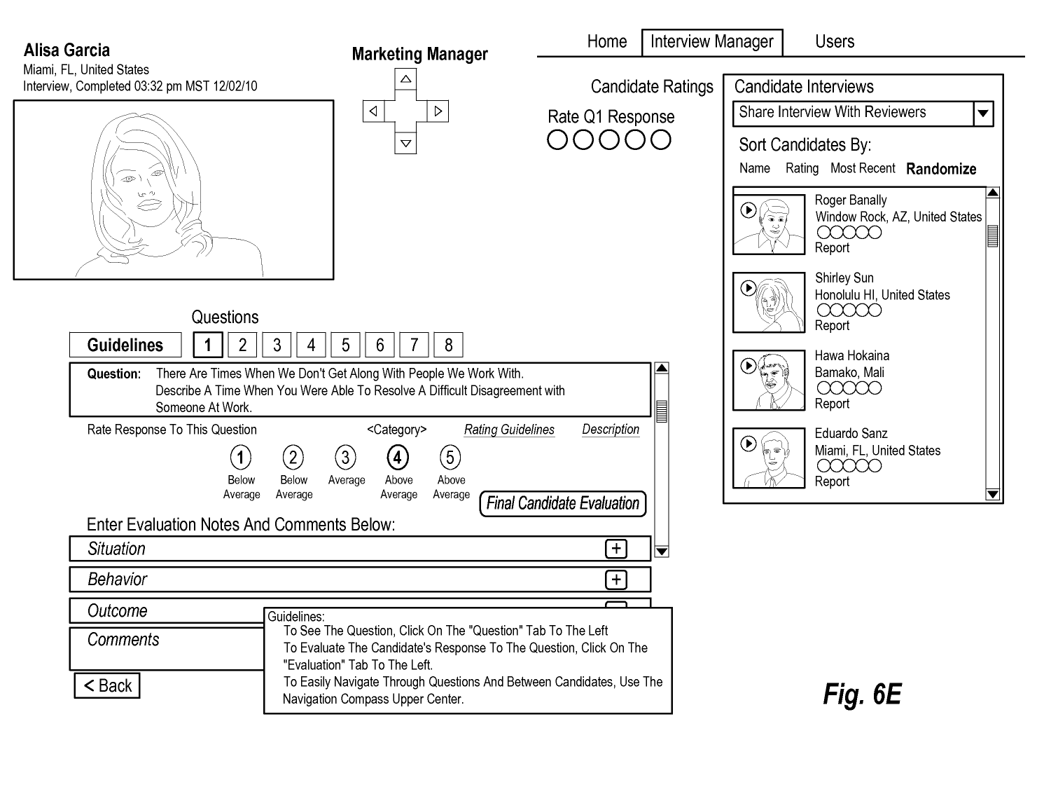

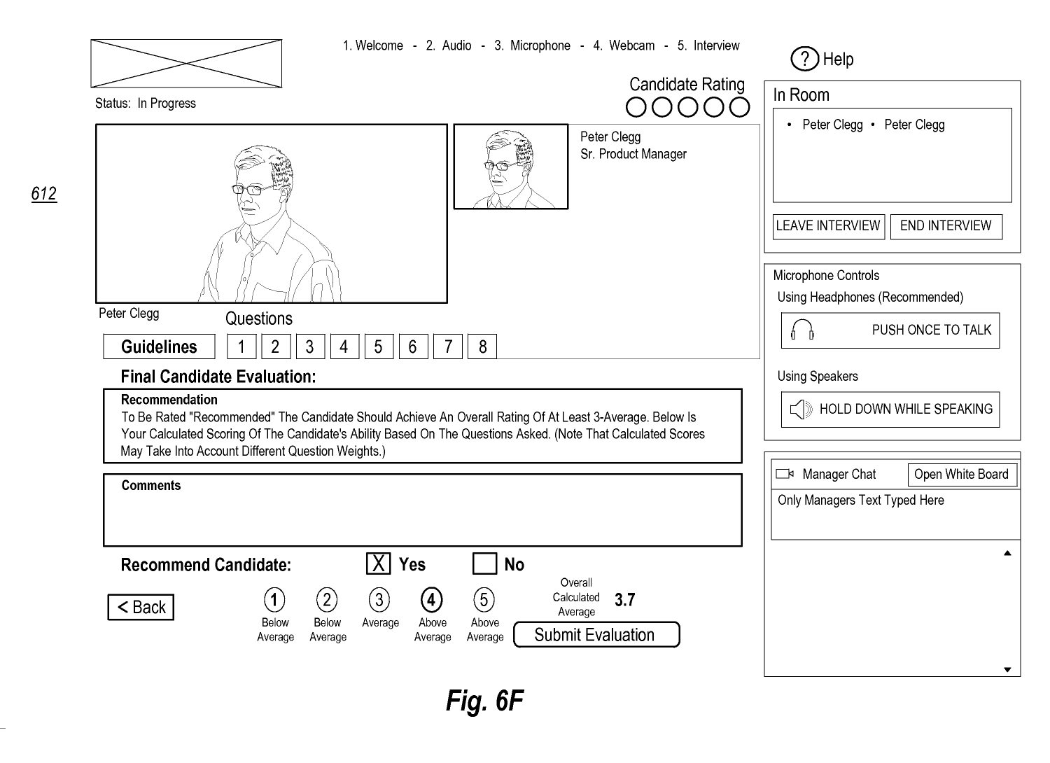

Referring now to FIGS. 6A through 6F, interviews created using the preceding tools are illustrated. FIG. 6A illustrates an example of a screen 602 providing interview guidelines for a two-way or panel interview. FIG. 6A illustrates providing interview instructions which are set in the interview framework. In some embodiments if interview instructions are not enabled in the interview builder as illustrated previously, embodiments may default to simple instructions on how to evaluate questions.

The interface 602 includes a next button that allows a user to advance through the various questions. On the upper right hand side of the interface 602 a candidate rating indicator is illustrated. However, this is not intended for user input but rather provides ongoing feedback of how a particular candidate is performing in a given interview. As illustrated, the interface 602 includes various other control features such as the ability to leave an interview, an interview, microphone and headset controls, speaker controls, chat tools to chat with others external to the interview, white board functionality, etc.

FIG. 6B illustrates another example of interview guidelines for an in person interview were no video or recording is performed. The interface 604 illustrated in FIG. 6B is similar to that shown in FIG. 6A except that various video controls are removed, and various indicators indicating that the interview does not include video functionality may be provided.

Referring now to FIG. 6C, a question screen 606 is illustrated for use in live interviews, such as two way interviews, panel interviews, and/or in-person interviews. As an interviewer advances through questions, questions will appear as shown in the interface 606. Additionally, if probes are enabled, the probes will appear as well. Embodiments may include interface elements that allow an interviewer to input various pieces of information regarding an interviewees answers to questions. Additionally, the interface 606 includes a “rate response to this question” interface which allows an interviewer to rate the interviewee's response. The “rate response to this question” interface may have been defined previously in the framework builder as illustrated in FIG. 2C at the “Define Scoring Scale” section 208. The interface 606 includes the ability to move to the next question or back to a previously asked question.

Referring now to FIG. 6D various enhancements to the interface 606 shown in FIG. 6C are illustrated. In particular, FIG. 6D illustrates that questions and probes can be expanded by clicking on an expansion user interface element. FIG. 6D further illustrates that selection of a ratings guidelines element causes a ratings guidelines description element 608 to be displayed to an interviewer displaying additional information on how to select a rating for a particular question. FIG. 6D further illustrates that additional information can be obtained by a user an interviewer regarding category description or other information such as illustrated by the display element 610.

FIG. 6E illustrates a question screen for virtual interviews. In this screen, an evaluator can select various questions, view candidates' recorded responses to the questions, enter evaluation information, rate candidates responses, etc.

FIG. 6F further illustrates the final evaluation screen 612. In the final evaluation screen 612 an interviewer can recommend candidates or determine a candidate's suitability for employment. In particular when all questions have been evaluated, recommendation instructions, comments, and candidate recommendations can be displayed if they were selected in the interview builder when the template was created. The user can then enter comments and either recommend a candidate or not. This particular screen 612 further includes an overall calculated average based on the ratings provided by the interviewer to previous questions. Once all information has been collected the submit evaluation button is available which allows the interviewer to submit the interview.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

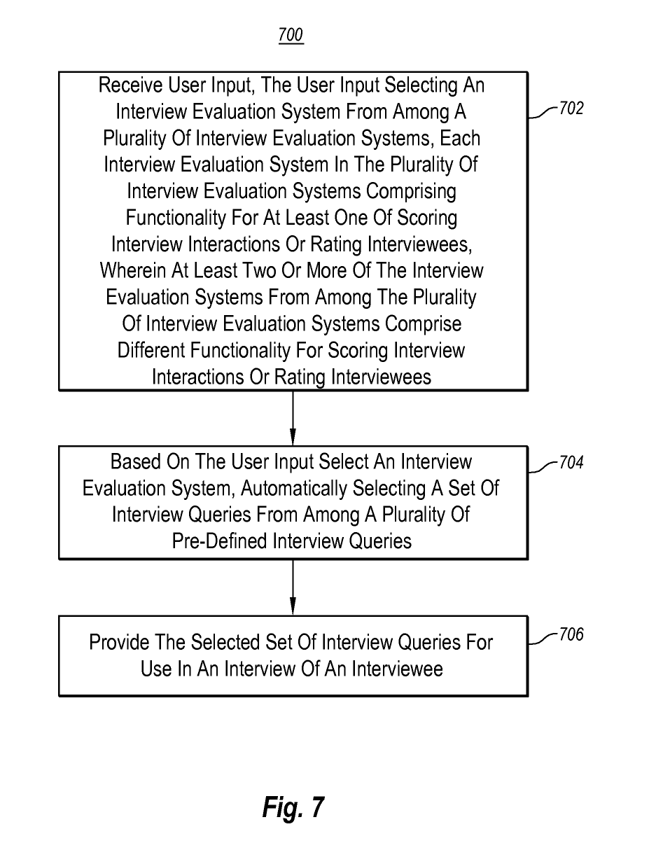

Referring now to FIG. 7, a method 700 is illustrated. The method 700 illustrates a method that may be practiced in a computing environment configured to automate at least a portion of interview processes. The method includes acts for selecting interview questions to be posed to an interviewee. The method includes receiving user input, the user input selecting an interview evaluation system from among a plurality of interview evaluation systems (act 702). Each interview evaluation system in the plurality of interview evaluation systems includes functionality for at least one of scoring interview interactions or rating interviewees. Embodiments may alternatively or additionally include functionality for evaluating interview interactions or interviewees. For example, some embodiments may implement a structured evaluation for comments. For example, a system may allow an evaluator to enter comments in a form of “situation (describing a particular situation described by an interviewee)”, “behavior (describing an interviewee's behavior in the previously described situation)” and “outcome (describing the outcome based on the behavior)”, allowing the evaluator to comment in an ordered and structured way. This structures evaluation comments in addition to the structured rating/scoring model. FIG. 6C illustrates an interface that facilitates the ability to score interview interactions as well as automated rating of interviewees. These features are directly related to the framework (which is an interview evaluation system) to which questions belong. At least two or more of the interview evaluation systems from among the plurality of interview evaluation systems comprise different functionality for scoring interview interactions or rating interviewees. Thus, for example, the same question may have different scoring criteria as a result of belonging to different frameworks.

The method 700 further includes based on the user input selecting an interview evaluation system, automatically selecting a set of interview queries from among a plurality of pre-defined interview queries (act 704). For example, as illustrated above, selecting a framework 102 results in selection of questions from among the set of question 108.

The method 700 further includes providing the selected set of interview queries for use in an interview of an interviewee (act 706). Various alternatives are illustrated above. However, in one example, providing the selected set of interview queries for use in an interview of an interviewee may include providing the selected set of interview queries in a format that can be printed and provided to a user for performing an in person interview. In an alternative embodiment, providing the selected set of interview queries for use in an interview of an interviewee may include providing the selected set of interview queries to an automated interview systems that allows an interviewee to be interviewed by the automated system which provides a user interface which poses the interview queries and allows the interviewee to respond by to the queries by interacting with the user interface.

Some embodiments of the method 700 may be practiced where automatically selecting a set of interview queries from among a plurality of pre-defined interview queries includes selecting questions based on a hierarchical arrangement of the interview evaluation system. The interview evaluation system includes a hierarchical level for types of questions, a hierarchical level for categories of types of questions, and one or more individual questions within each category. An example of such hierarchies are illustrated in FIG. 1.

In some embodiments of the method 700, receiving user input, the user input selecting an interview evaluation system from among the plurality of interview evaluation systems may include the user input selecting more than one interview evaluation system from among a plurality of interview evaluation systems. In some such embodiments, the selected set of interview queries includes queries for each of selected interview evaluation systems. For example, multiple frameworks may be used for a single interview. Thus, questions for the different frameworks may be selected. Some of the questions may belong to more than one framework and may be used in an interview for a plurality of different frameworks.

The method 700 may further include iteratively receiving user input selecting an interview query from among the selected set of interview queries, iteratively receiving user input rating an interviewee's response to the interview query from among the selected set of interview queries, and iteratively updating and displaying an interviewee rating as a result of user input rating an interviewee's response. For example, FIG. 6A illustrates a candidate rating indicator that can provide a cumulative indication of a candidate's rating as an interview progresses. As an interviewer asks questions and rates responses, the candidate rating can change based on an interview framework being used.

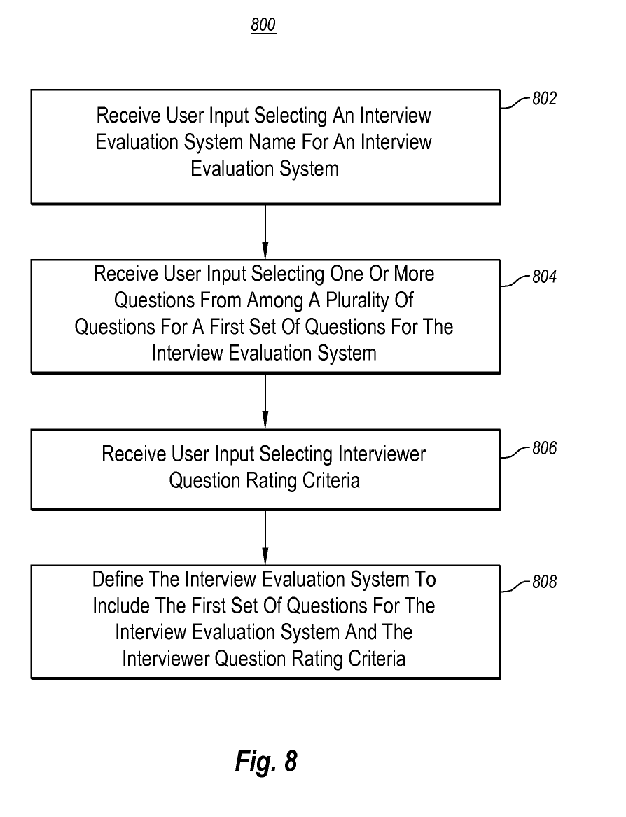

Referring now to FIG. 8, a method of defining an interview evaluation system for a set of interview evaluation systems is illustrated. Each interview evaluation system in the set of interview evaluation systems includes functionality for at least one of scoring interview interactions or rating interviewees. At least two or more of the interview evaluation systems from among the set of interview evaluation systems include different functionality for scoring interview interactions or rating interviewees. For example, as illustrated in FIG. 2C, different scoring scales and other rating criteria can be defined for different interview evaluation systems. The method 800 includes receiving user input selecting an interview evaluation system name for an interview evaluation system (act 802).

The method 800 further includes receiving user input selecting one or more questions from among a plurality of questions for a first set of questions for the interview evaluation system (act 804). At least one or more same questions in the plurality of questions are selected to belong to different interview evaluation systems such that at least two interview evaluation systems have overlapping questions. Thus, the same questions can be used by different interview evaluation systems.

The method 800 further includes receiving user input selecting interviewer question rating criteria (act 806). As noted, FIG. 2C illustrates an example where different rating criteria can be defined.

The method 800 further includes defining the interview evaluation system to include the first set of questions for the interview evaluation system and the interviewer question rating criteria (act 808).

The method 800 may further include receiving user input defining a category for at least a portion of the first set of questions. Some such embodiments may further include receiving user input defining one or more sub-categories for one or more of the categories. For example, FIG. 1 illustrates Frameworks 102 being divided into category types 104, and category types 104 being divided into categories 106. Some such embodiments may be practiced where receiving user input selecting one or more questions from among a plurality of questions includes assigning questions to one or more of the sub-categories. For example, as illustrated in FIG. 1, questions can be assigned to different category types 106.

The method 800 may be practiced where receiving user input selecting interviewer question rating criteria includes receiving user input determining a fixed number of options for rating responses to questions. For example, FIG. 2C illustrates an ability to define a scoring scale to have a fixed number of options for rating questions.

The method 800 may further include receiving user input defining one or more probes for one or more of the one or more questions. The one or more probes represent promptings to an interviewer to further explore interviewee responses to a question.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment configured to automate at least a portion of interview processes, a method of selecting interview questions to be posed to an interviewee, the method comprising:
receiving user input, the user input selecting an interview evaluation system from among a plurality of interview evaluation systems, each interview evaluation system in the plurality of interview evaluation systems comprising functionality for at least one of scoring interview interactions or rating interviewees, wherein at least two or more of the interview evaluation systems from among the plurality of interview evaluation systems comprise different functionality for scoring interview interactions or rating interviewees;
based on the user input selecting an interview evaluation system, automatically selecting a set of interview queries from among a plurality of pre-defined interview queries; and
providing the selected set of interview queries for use in an interview of an interviewee.

2. The method of claim 1, wherein providing the selected set of interview queries for use in an interview of an interviewee comprises providing the selected set of interview queries in a format that can be printed and provided to a user for performing an in person interview.

3. The method of claim 1, wherein providing the selected set of interview queries for use in an interview of an interviewee comprises providing the selected set of interview queries to an automated interview systems that allows an interviewee to be interviewed by the automated system which provides a user interface which poses the interview queries and allows the interviewee to respond by to the queries by interacting with the user interface.

4. The method of claim 1, wherein automatically selecting a set of interview queries from among a plurality of pre-defined interview queries comprises selecting questions based on a hierarchical arrangement of the interview evaluation system, wherein the interview evaluation system comprises a hierarchical level for types of questions, a hierarchical level for categories of types of questions, and one or more individual questions within each category.

5. The method of claim 4, wherein one or more individual queries in the plurality of pre-defined interview queries belong within more than one category, type, and/or interview evaluation system.

6. The method of claim 1, wherein receiving user input, the user input selecting an interview evaluation system from among the plurality of interview evaluation systems comprises the user input selecting more than one interview evaluation system from among a plurality of interview evaluation systems, and wherein the selected set of interview queries includes queries for each of selected interview evaluation systems.

7. The method of claim 1, further comprising:
iteratively receiving user input selecting an interview query from among the selected set of interview queries;
iteratively receiving user input rating an interviewee's response to the interview query from among the selected set of interview queries; and
iteratively updating and displaying an interviewee rating as a result of user input rating an interviewee's response.

8. A method of defining an interview evaluation system for a set of interview evaluation systems, wherein each interview evaluation system in the set of interview evaluation systems comprising functionality for at least one of scoring interview interactions or rating interviewees, wherein at least two or more of the interview evaluation systems from among the set of interview evaluation systems comprise different functionality for scoring interview interactions or rating interviewees the method comprising:
receiving user input selecting an interview evaluation system name for an interview evaluation system;
receiving user input selecting one or more questions from among a plurality of questions for a first set of questions for the interview evaluation system, wherein at least one or more same questions in the plurality of questions are selected to belong to different interview evaluation systems such that at least two interview evaluation systems have overlapping questions;
receiving user input selecting interviewer question rating criteria;
defining the interview evaluation system to include the first set of questions for the interview evaluation system and the interviewer question rating criteria.

9. The method of claim 8, further comprising receiving user input defining a category for at least a portion of the first set of questions.

10. The method of claim 9, further comprising receiving user input defining one or more sub-categories for one or more of the categories.

11. The method of claim 10, wherein receiving user input selecting one or more questions from among a plurality of questions comprises assigning questions to one or more of the sub-categories.

12. The method of claim 8, wherein receiving user input selecting interviewer question rating criteria comprises receiving user input determining a fixed number of options for rating responses to questions.

13. The method of claim 8, further comprising receiving user input defining one or more probes for one or more of the one or more questions, wherein the one or more probes probe represent promptings to an interviewer to further explore interviewee responses to a question.

14. In a computing environment configured to automate at least a portion of interview processes, one or more physical computer readable media comprising computer executable instructions that when executed by one or more processors cause the following to be performed:
receiving user input, the user input selecting an interview evaluation system from among a plurality of interview evaluation systems, each interview evaluation system in the plurality of interview evaluation systems comprising functionality for at least one of scoring interview interactions or rating interviewees, wherein at least two or more of the interview evaluation systems from among the plurality of interview evaluation systems comprise different functionality for scoring interview interactions or rating interviewees;
based on the user input selecting an interview evaluation system, automatically selecting a set of interview queries from among a plurality of pre-defined interview queries; and
providing the selected set of interview queries for use in an interview of an interviewee.

15. The one or more computer readable media of claim 14, wherein providing the selected set of interview queries for use in an interview of an interviewee comprises providing the selected set of interview queries in a format that can be printed and provided to a user for performing an in person interview.

16. The one or more computer readable media of claim 14, wherein providing the selected set of interview queries for use in an interview of an interviewee comprises providing the selected set of interview queries to an automated interview systems that allows an interviewee to be interviewed by the automated system which provides a user interface which poses the interview queries and allows the interviewee to respond by to the queries by interacting with the user interface.

17. The one or more computer readable media of claim 14, wherein automatically selecting a set of interview queries from among a plurality of pre-defined interview queries comprises selecting questions based on a hierarchical arrangement of the interview evaluation system, wherein the interview evaluation system comprises a hierarchical level for types of questions, a hierarchical level for categories of types of questions, and one or more individual questions within each category.

18. The method of claim 4, wherein one or more individual queries in the plurality of pre-defined interview queries belong within more than one category, type, and/or interview evaluation system.

19. The one or more computer readable media of claim 14, wherein receiving user input, the user input selecting an interview evaluation system from among the plurality of interview evaluation systems comprises the user input selecting more than one interview evaluation system from among a plurality of interview evaluation systems, and wherein the selected set of interview queries includes queries for each of selected interview evaluation systems.

20. The one or more computer readable media of claim 14, further comprising computer executable instructions that when executed by one or more processors cause the following to be performed:
iteratively receiving user input selecting an interview query from among the selected set of interview queries;
iteratively receiving user input rating an interviewee's response to the interview query from among the selected set of interview queries; and
iteratively updating and displaying an interviewee rating as a result of user input rating an interviewee's response.
